(19) United States
(12) Patent Application Publication
(10) Pub. No.: US 2026/0115959 A1
(43) Pub. Date: Apr. 30, 2026

(54) FOOD-PROCESSING DEVICE

(71) Applicant: PROVISUR TECHNOLOGIES, INC., Chicago, IL (US)

(72) Inventors: Jürgen BIALY, Oeschebüttel (DE); Klaus GUGGEMOS, Rettenberg (DE); Paul GOROLL, Waltenhofen (DE); Matthias HINDORFF, Waltenhofen (DE); Alexander MAY, Waltenhofen (DE); Florian MOHR, Sulzberg (DE); Klaus Dieter SCHROFF, Konstanz (DE)

(73) Assignee: PROVISUR TECHNOLOGIES, INC., Chicago, IL (US)

(21) Appl. No.: 19/431,469

(22) Filed: Dec. 23, 2025

Related U.S. Application Data
(62) Division of application No. 18/548,485.

(30) Foreign Application Priority Data
Mar. 3, 2021 (DE) 10 2021 105 093.6

(51) Int. Cl. B26D 7/32; B26D 5/00

(52) U.S. Cl. CPC B26D 7/32; B26D 5/007; B26D 2210/02

(57) ABSTRACT

A food-processing device for cutting food products into slices. The food-processing device according includes a cutting device for cutting the slices from the food products, and a conveyor which receives the cut slice. The conveyor is arranged so that the cut slices fall from the cutting device thereon. The conveyor is a discontinuous conveyor which conveys the deposited slices discontinuously.

### FIELD

The invention relates to a food-processing device for slicing food products (e.g. pieces of meat, salami sticks, pieces of cheese) into slices. Furthermore, the invention relates to an associated operating method for such a food-processing device.

### BACKGROUND

In the prior art, a food-processing device is known which automatically slices food products (e.g. pieces of meat, salami sticks, pieces of cheese) into slices by means of a slicer, the slices then falling onto a conveyor on which stacks of slices are formed which are then transported away. In the known food-processing devices, this conveyor is in the form of a conveyor belt. However, such conveyor belts are relatively costly and inflexible.

### SUMMARY

The invention is therefore based on the task of creating a correspondingly improved food-processing device. Furthermore, the invention is based on the task of specifying a corresponding operating method for such a food-processing device.

This task is solved by a food-processing device according to the main claim or by a corresponding operating method according to the independent claim.

The food-processing device according to the invention comprises first of all, in accordance with the prior art, a cutting device for cutting slices or at least a single slice from the food products (e.g. pieces of meat, salami sticks, pieces of cheese). Such cutting devices are known per se from the prior art and therefore need not be described in detail. At this point, it is only to be mentioned that the cutting device has a cutting blade, which can be designed, for example, as a sickle blade and rotates about a fixed axis of rotation. However, it is alternatively also possible that the cutting blade performs an orbital movement, so that the cutting blade rotates about the axis of rotation, while the axis of rotation itself performs an orbital movement. Furthermore, it should be mentioned that the cutting device usually comprises a feeding device which moves the food products (e.g. pieces of meat, salami sticks, pieces of cheese) in a feeding direction into the cutting plane in which the food products are then sliced. The invention is not limited to specific designs with respect to the structural design of this feeding device. For example, the feeding device may comprise conveyor belts which grip the individual food products at the top and/or bottom and convey them into the cutting plane. Alternatively, or additionally, a gripper may be provided which grips the rear end of the food products, the gripper thus moving the food products into the cutting plane.

Furthermore, in accordance with the prior art, the food-processing device according to the invention also comprises a conveyor which receives the cut slices after a cutting operation, the conveyor preferably being arranged in the falling line of the slices so that the cut slices fall automatically from the cutting device onto the conveyor.

The invention is now characterized by the fact that the conveyor is not designed as a conveyor belt, but as a discontinuous conveyor, which conveys the deposited slices discontinuously in contrast to a conveyor belt. The term “discontinuous conveyor” used in the context of the invention means, in accordance with the usual technical terminology, that the discontinuous conveyor cannot convey the product to be conveyed (e.g. a stack of slices) continuously, but only discontinuously. It should be noted, however, that product placement on the discontinuous conveyor can be continuous within a portion.

In a preferred embodiment of the invention, the discontinuous conveyor comprises at least one conveyed-products carrier which is freely movable in two dimensions within a conveying surface without being bound to a fixed conveying path and which receives the cut slices. Such conveyed-products carriers are in themselves already known from the prior art and are described, for example, in patent application DE 10 2020 105 678.8, so that the contents of this earlier patent application can be fully attributed to the present description with regard to the structural design of the conveyed-products carrier. Furthermore, such conveyed-products carriers are also available from the German company Beckhoff Automation Gmbh & Co. KG under the product name “XPlanar”.

Furthermore, in the preferred embodiment of the invention, the discontinuous conveyor comprises a contactless drive system that moves the conveyed-products carrier within the conveying surface along a freely programmable conveying path without any contact between the conveyed-products carrier on the one hand and the conveying surface on the other hand. Such contactless drive systems work, for example, with the magnetic levitation technology known per se, but other drive technologies are also possible in principle within the scope of the invention. For example, such contactless drive systems are available from the German company Beckhoff Automation Gmbh & Co. KG under the product name “XPlanar”.

In one variant of the invention, the conveying surface of the contactless drive system runs essentially horizontally, with minor angular deviations from the horizontal of less than ±10°, ±5° or ±2° being possible.

In another variant of the invention, on the other hand, the conveying surface of the contactless drive system runs essentially vertically, whereby again slight angular deviations from the vertical of less than ±10°, ±5° or ±2° are possible.

In a further variant of the invention, on the other hand, it is provided that the conveying surface of the contactless drive system is inclined at an angle.

In the preferred embodiment, the contactless drive system consists of several modules which preferably adjoin one another without gaps and form the continuous conveying surface, whereby the conveying path within the conveying surface is freely programmed. The individual modules can be rectangular so that the conveying surface can be composed of the modules without gaps. Such a technical realization of the contactless drive system also corresponds to the “XPlanar” drive system already briefly mentioned above.

Furthermore, it is possible within the scope of the invention for the food-processing device to comprise a lifting device for raising or lowering the conveyed-products carrier, in particular in the vertical direction. The lifting device can, for example, allow a stroke of the conveyed-products carrier of at least 2 mm, 3 mm, 4 mm, 5 mm, 10 mm, 20 mm, 40 mm or 80 mm.

For the technical realization of such a lifting device, various possibilities exist within the scope of the invention, which are briefly described below.

In one variant of the invention, the conveying surface runs essentially horizontally, whereby the lifting device raises or lowers the conveyed-products carrier by means of the contactless drive system relative to the conveying surface located below it essentially at right angles to the conveying surface. The lifting device is thus integrated into the contactless drive system, which simply has to be controlled accordingly in order to raise or lower the conveyed-products carrier.

In another variant of the invention, however, the lifting device is independent of the contactless drive system, whereby the lifting device also raises or lowers the conveyed-products carrier relative to the conveying surface below. The difference between the two above-mentioned invention variants is that the lifting device in the first invention variant is integrated into the contactless drive system, whereas the lifting device in the second invention variant described above is designed independently and separately from the contactless drive system.

In a third variant of the invention, the lifting device is also independent of the contactless drive system, whereby the lifting device raises or lowers the conveyed-products carrier together with the module of the drive system located below it.

Finally, there is also the possibility that the conveying surface is substantially vertical, so that a movement of the conveyed-products carrier in the conveying surface can also be used to raise or lower the conveyed-products carrier.

It has already been mentioned above that during a cutting operation the cut slices preferably fall automatically onto the conveyed-products carrier. During a cutting process, the conveyed-products carrier is therefore preferably arranged in the fall line of the slices, so that the slices fall automatically onto the conveyed-products carrier due to the gravitational force. A stack of slices can then form on the conveyed-products carrier, consisting of several slices lying on top of each other, whereby the slices can also be laterally offset to then form a shingled stack of slices.

The height of fall from which the slices fall from the cutting device onto the top of the stack of slices depends on the height of the stack of slices. If, for example, a high stack of slices has already formed on the conveyed-products carrier, the height of fall is considerably lower than when a slice is deposited on a conveyed-products carrier that is still empty. However, it is fundamentally desirable that the height of fall of the slices is constant during operation. The above-mentioned lifting device can therefore be controlled during a cutting operation in such a way that the conveyed-products carrier is lowered slightly each time after a slice has been deposited, in order to keep the height of fall of the slices constant. In this way, it can be achieved that the height of fall of the slices when forming a stack of slices is independent of the height of the stack of slices.

It should also be mentioned that the cutting device can operate in multiple tracks and then has several parallel conveyor tracks in which the food products (e.g. meat pieces, salami sticks, cheese pieces) are moved at a certain feed speed into the cutting plane, where the food products located next to each other are then cut into slices. In such a multi-track cutting process, the discontinuous conveyor then preferably also comprises several conveyed-products carriers which are assigned to the individual conveyor tracks of the cutting device. The food-processing device can thus cut the food products in multiple tracks and also convey them away in multiple tracks through conveyed-products carriers. It is also possible for several conveyed-products carriers to work together and be jointly loaded with slices.

In the case of the above-described multi-track slice deposition on several conveyed-products carriers, it is also possible for the individual conveyed-products carriers to be moved forward by a predetermined offset in a certain direction after a slice has been deposited, so that the slices form a shingled portion on the conveyed-products carrier. The offset between the deposits of the successive slices can be set individually for the individual conveyed-products carriers, so that a desired portion shape can be set individually for the individual conveyor tracks. For example, a normal stack of slices can be realized, a shingled stack of slices, or an ovally laid slices, to name just a few examples.

In the preferred embodiment of the invention, the food-processing device additionally comprises a scale for measuring the weight of the deposited slices or of the conveyed-products carrier with the slices deposited thereon.

In one embodiment of the invention, this scale is integrated in the conveyed-products carrier and comprises, for example, a piezo element which is compressed depending on the loading state of the conveyed-products carrier and outputs a corresponding weight signal. The weight signal determined by the piezo element can then be transmitted wirelessly, for example, by means of a transmitter integrated in the conveyed-products carrier. For example, an RFID (radio-frequency identification) transmitter, a Bluetooth transmitter or an NFC (near field communication) transmitter can be used for this purpose, to name just a few examples.

In contrast, in another embodiment of the invention, the scale is integrated into the contactless drive system. Thus, in practice, the contactless drive system holds the individual conveyed-products carrier in a suspended state above the conveying surface below, with a gap between the conveying surface and the conveyed-products carrier. The size of this gap depends, on the one hand, on the total weight of the conveyed-products carrier including the product to be conveyed on it and, on the other hand, on the drive power of the drive system with which the conveyed-products carrier is kept in suspension. In this embodiment of the invention, the food-processing device has a measuring device which measures the distance between the conveyed-products carrier and the conveying surface, i.e. the size of the gap between the conveyed-products carrier and the conveying surface. In addition, a control device is provided to determine the weight of the conveyed-products carrier with the conveyed product thereon. There are basically two possibilities for this, which are described briefly below.

One possibility is that the control device controls the contactless drive system in such a way that the gap between the conveyed-products carrier and the conveying surface below it remains constant regardless of the weight of the conveyed product. For this purpose, the drive power with which the contactless drive system is controlled in order to keep the conveyed-products carrier in suspension is adjusted. The drive power required for this is then used as a measure of the total weight of the conveyed-products carrier.

Another possibility, on the other hand, is to keep the drive power of the contactless drive system constant so that the distance between the conveyed-products carrier and the conveying surface below it then varies as a function of the total weight of the conveyed-products carrier and can thus serve as a measure of the weight of the conveyed-products carrier.

The aforementioned measuring device for determining the distance between the conveyed-products carrier and the conveying surface below it can comprise, for example, a distance sensor or a camera, to name just a few examples.

It has already been briefly mentioned above that the conveying surface can also run essentially vertically. The conveyed-products carriers can then be moved parallel to the vertical conveying surface by the contactless drive system. A separate loading surface is then provided for receiving the conveyed product (e.g. stacks of slices), which is attached to the conveyed-products carrier and is aligned at right angles to the conveying surface.

Here, it is also possible that the conveyed-products carrier with the loading surface is tilted parallel to the conveying surface during the movement of the conveyed-products carrier in order to prevent the conveyed product from sliding off the conveyed-products carrier. Thus, during acceleration, the conveyed-products carrier is preferably tilted forward in the conveying direction, whereas during deceleration, the conveyed-products carrier is preferably tilted backward against the conveying direction. In this way, it can also be achieved that the resultant of the weight force acting on the conveyed product and the inertia force acting on the conveyed product is always aligned at right angles to the loading surface, so that the conveyed product does not slip off the loading surface.

Furthermore, the food-processing device according to the invention may also comprise a conventional conveyor belt conveying the food products, in particular parallel to the conveying surface of the contactless drive system. Thus, a hybrid system may be provided for conveying the food products, comprising conveyor belts on the one hand and discontinuous conveyors on the other hand. The discontinuous conveyor then preferably moves the conveyed products to the conveyor belt, where the conveyed products (e.g. stacks of slices) are then transferred to the conventional conveyor belt.

Furthermore, it should be mentioned that the invention does not only claim protection for the above-described food-processing device according to the invention. Rather, the invention also claims protection for a corresponding operating method. The individual process steps of the operating method according to the invention already result from the above description of the food-processing device according to the invention, so that a separate description of the operating method can be dispensed with.

Other advantageous further embodiments of the invention are indicated in the dependent claims or are explained in more detail below together with the description of the preferred embodiments of the invention with reference to the figures.

### BRIEF DESCRIPTION OF THE DRAWINGS

FIG. 1 shows a schematic side view of a food-processing device according to the invention.

FIG. 2 shows a schematic top view of the food-processing device from FIG. 1.

FIG. 3 shows a side view of a single conveyed-products carrier of the food-processing device of FIGS. 1 and 2.

FIG. 4 shows a top view of the conveyed-products carrier according to FIG. 3.

FIG. 5 shows a schematic side view of a take-off conveyor for removing the foodstuff products from the conveyed-products carrier.

FIG. 6 shows a schematic side view of another embodiment of the food-processing device according to the invention with a vertical orientation of the conveying surface.

FIG. 7 shows a front view of the cutting device of FIG. 6.

FIGS. 8A-8C show examples of different portion shapes that can be realized with the food-processing device according to the invention.

FIG. 9 shows a modification of FIG. 3 with an integrated piezo element for weight measurement.

### DETAILED DESCRIPTION

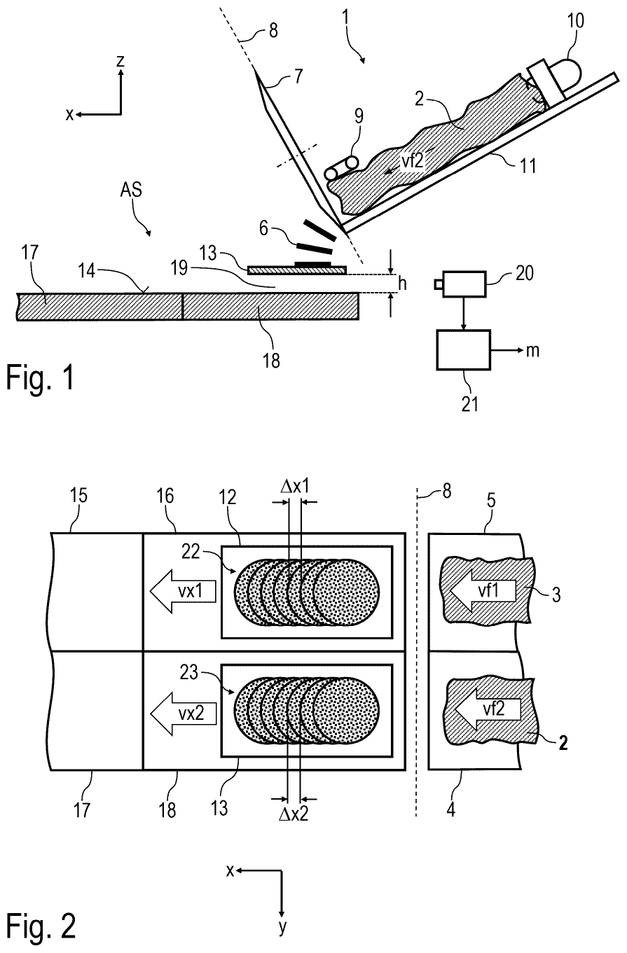

In the following, the embodiment according to FIGS. 1-5 will now be described.

First of all, the food-processing device in this embodiment comprises a cutting device 1, which can be of largely conventional design and cuts food products 2, 3 into slices 6 in two parallel conveyor tracks 4, 5.

For this purpose, the cutting device 1 comprises a cutting blade 7 which rotates in a cutting plane 8 during operation and is driven by an electric motor which is not shown.

In addition, the cutting device 1 comprises a feeding device which moves the food products 2, 3 into the cutting plane 8 at a specific feed speed vf1, vf2. For this purpose, the feeding device can have a conveyor belt 9 that grips the food products 2 or 3 at the top and conveys them into the cutting plane 8. In addition, the feeding device can also have a gripper 10 which grips the food products 2, 3 at their rear side and pushes them into the cutting plane 8. In the side view in FIG. 1, only the conveyor belt 9 and the gripper 10 for the food product 2 are shown. On the opposite side, however, there is also an unidentified conveyor belt for the other food product 3 and likewise an associated gripper for the food product 3. The food products 2, 3 are here conveyed on an inclined product support 11 into the cutting plane 8, as is known per se from the prior art. However, the design of the feeding device described above is only exemplary, since other designs of the feeding device are also possible within the scope of the invention.

Furthermore, in this embodiment, the food-processing device comprises a plurality of conveyed-products carriers 12, 13 which can be moved parallel to a horizontal conveying surface 14 by a contactless drive system AS. The contactless drive system AS is here composed of several rectangular modules 15-18, which are assembled without gaps and form the continuous conveying surface 14. For simplification, only the four modules 15-18 are shown. In practice, however, the conveying surface 14 is composed of a larger number of modules. The contactless drive system AS operates here according to the magnetic levitation technique as known from the commercially available system “XPlanar” mentioned at the beginning. FIG. 1 shows that the conveyed-products carrier 13 is held in suspension above the conveying surface 14, so that a gap 19 is formed between the conveyed-products carrier 13 and the conveying surface 14. The height h of the gap 19 is detected by a camera 20 and reported to a control device 21, which uses it to determine the total mass m of the conveyed-products carrier 13 with the conveyed product on it. One possibility for this is that the drive power of the contactless drive system AS is controlled in such a way that the height h of the gap 19 remains constant regardless of the total weight m of the conveyed-products carrier 13. The drive power required for this then forms a measure of the total mass m of the conveyed-products carrier 13.

During a cutting process, the conveyed-products carriers 12, 13 are arranged below the cutting device in the line of fall of the slices 6, so that the slices 6 fall onto the conveyed-products carrier 13 or 14 and form stacks of slices 22, 23 there.

FIG. 2 shows that the stacks of slices 22, 23 are shingled. This means that the superimposed slices have a certain offset Δx1 or Δx2 to each other. To realize these shingled stacks of slices 22, 23, the conveyed-products carriers 12, 13 are moved by the corresponding offset Δx1 or Δx2 after each of the slices 6 has been deposited, so that the desired slice offset is achieved.

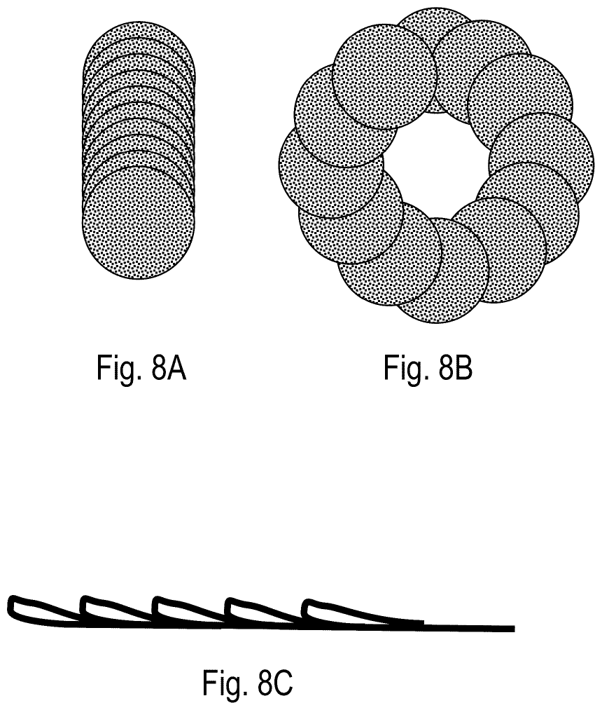

However, within the scope of the invention, it is also possible for other portion shapes to be generated, such as those shown in FIGS. 8A-8C, as will be described in detail. It should be mentioned here that the different portion shapes can be realized without hardware adaptations by a software modification alone. This distinguishes the food-processing device according to the invention from conventional food-processing devices, in which a change of the portion shape is only possible with mechanical changes.

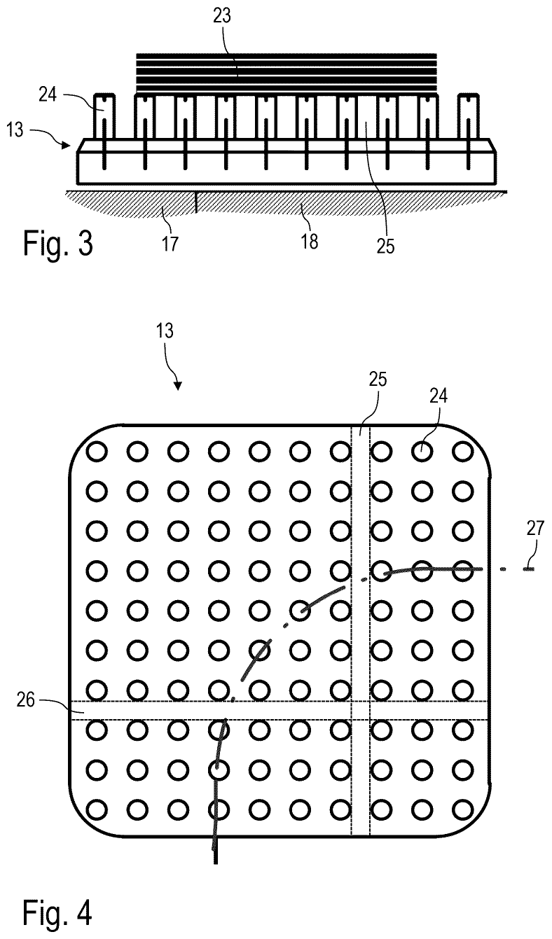

In the following, the conveyed-products carrier 13 will now be described in more detail, with reference to FIGS. 3 and 4. Basically, the construction and the mode of operation of the conveyed-products carrier are known from the earlier patent application DE 10 2020 105 678.8, so that the contents of that patent application can be fully attributed to the present description with respect to the construction of the conveyed-products carrier 13. Furthermore, it should be mentioned that the other conveyed-products carriers can be constructed in the same way.

On the upper side of the conveyed-products carrier 13 there are numerous pins 24, each of which has a cylindrical cross-section and projects vertically upwards. The pins 24 are arranged here in a matrix-like manner in rows and columns, two columns of the pins 24 each enclosing a recess 25, just as two rows of the pins 24 enclose a recess 26.

FIG. 4 shows by way of example that the conveyed-products carrier 13 can be moved along a curved conveying path 27, the course of the conveying path 27 shown being only exemplary.

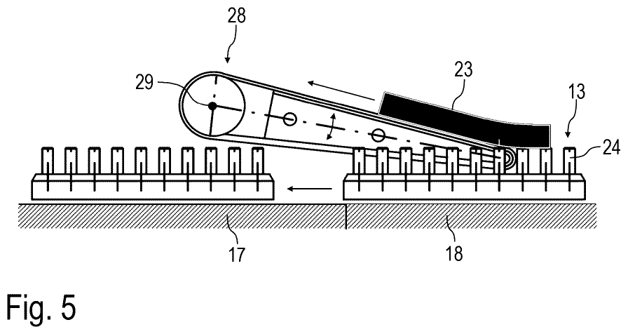

The recesses 25, 26 serve to remove the stack of slices 23 from the conveyed-products carrier 13, as can be seen in FIG. 5. For this purpose, a pivotable take-off conveyor 28 is provided, which can be pivoted about a pivot axis 29 in the direction of the double arrow. The take-off conveyor 28 consists of several parallel narrow knife conveyors (finger conveyors), which can each dive into the recesses 25 or 26 between the pins 24 of the conveyed-products carrier 13 in order to then convey away the stack of slices 23. The construction and the mode of operation of the take-off conveyor 28 are also described in the earlier patent application DE 10 2020 105 678.8, so that the contents of this earlier patent application are to be fully attributed to the present description with regard to the construction and the mode of operation of the take-off conveyor 28.

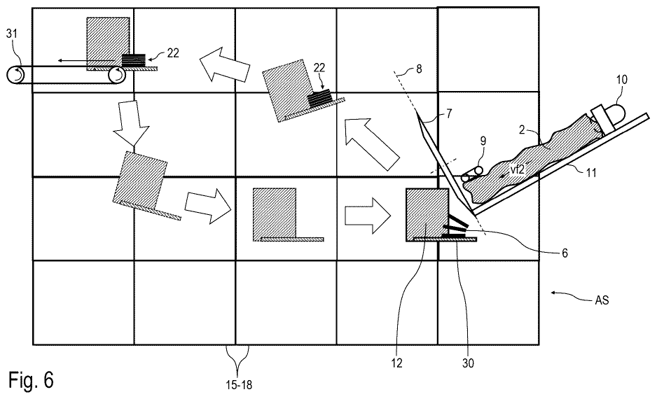

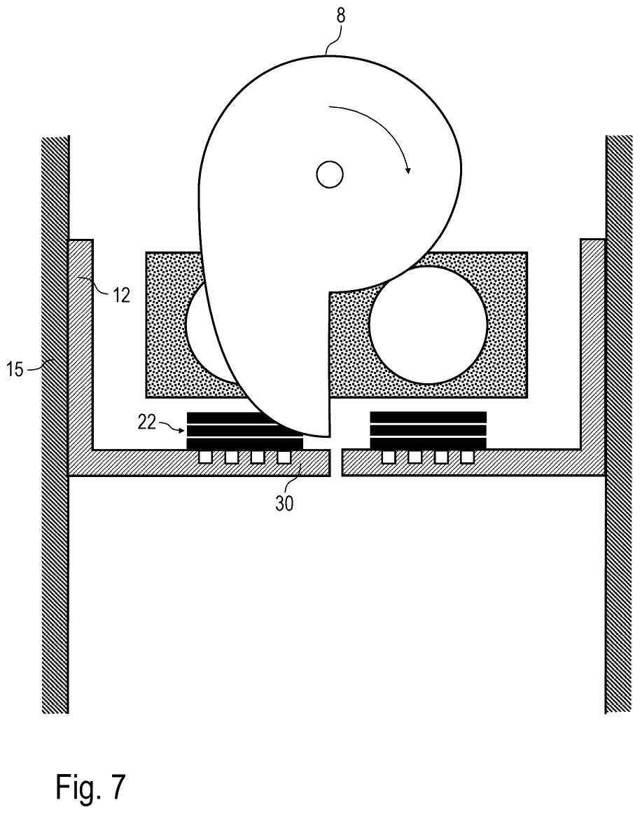

In the following, the alternative embodiment of a food-processing device according to the invention will now be described, which is shown schematically in FIGS. 6 and 7.

In this embodiment, the cutting device 1 largely corresponds to the embodiment described above, so that reference is made to the above description in order to avoid repetition, the same reference signs being used for corresponding details.

A special feature of this embodiment, however, is that the conveying surface of the contactless drive system AS is aligned vertically here, i.e. parallel to the drawing plane. The conveyed-products carrier 12 can thus be moved in vertical and horizontal direction parallel to the conveying surface, whereby the conveying surface is composed without gaps of the modules 15-18 shown here only schematically. The conveying path within the conveying surface is freely programmable.

A loading surface 30, which is aligned at right angles to the conveying surface of the contactless drive system AS and serves to receive the slices 6, is attached to the conveyed-products carrier 12. The loading surface can be designed in the manner described in German patent application DE 10 2020 105 678.8. The contents of this patent application are therefore fully attributable to the present description.

For slice deposition from the cutting device 1, the conveyed-products carrier 12 is then positioned by the contactless drive system AS in such a way that the loading surface 30 is in the line of fall of the slices 6, so that the slices cut off by the cutting device 1 fall onto the loading surface 30.

After the stack of slices 22 has been deposited on the loading surface 30 of the conveyed-products carrier 12, the conveyed-products carrier 12 is then moved in the direction of the block arrows to a conveyor belt 31 which takes over the stack of slices 22 from the conveyed-products carrier 12. Here, the removal of the stack of slices 22 from the loading surface 30 of the conveyed-products carrier 12 is carried out by a take-off conveyor with several parallel knife conveyors which dive into elongated recesses (cf. FIG. 7) in the loading surface 30 and thereby engage under the stack of slices 21. The details of the product removal from the loading surface 30 of the conveyed-products carrier 12 are described in the German patent application DE 10 2020 105 678.8. The take-off conveyor is not shown here for simplicity.

Subsequently, the conveyed-products carrier 12 is then moved again in the direction of the block arrows to the cutting device 1 in order to pick up a new stack of slices.

When the loaded conveyed-products carrier 12 is moved, it can be tilted about a pivot axis running at right angles to the drawing plane in order to prevent the stack of slices 22 from slipping off the loading surface 30 due to the inertial forces occurring during the movement. For this purpose, the conveyed-products carrier 12 is tilted forward during acceleration in the direction of movement.

FIG. 7 shows a schematic front view of the above-described embodiment according to FIG. 6. From this illustration, it can be seen that the food-processing device can be constructed in a mirror image with two opposite conveying surfaces that are aligned parallel to each other.

FIGS. 8A-8C show various portion shapes that can be realized with the food-processing device according to the invention.

FIG. 8A shows a shingled stack of slices. For the realization of these portion shapes, the respective conveyed-products carrier must be moved further by a certain offset in each case after the deposition of a slice, namely in a linear direction.

FIG. 8B, on the other hand, shows a different portion shape in which the individual slices are stacked in a circular shingled pattern. In order to realize this portion shape, the associated conveyed-products carrier must be rotated around the vertical axis when the slices are deposited, so that the slices then fall one after the other, shingled according to the circular shape, onto the conveyed-products carrier.

Furthermore, FIG. 8C shows a folded arrangement of the individual slices, which can also be realized by a corresponding movement of the associated conveyed-products carrier during the slice deposition.

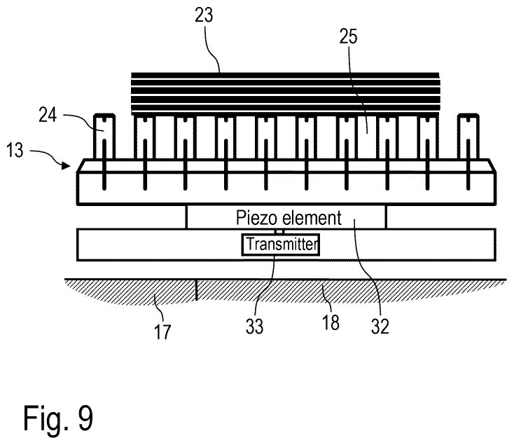

Finally, FIG. 9 shows a modification of FIG. 3, so that in order to avoid repetition, reference is made to the above description of FIG. 3, with the same reference signs being used for corresponding details.

A special feature of this embodiment is that a piezo element 32 is integrated in the conveyed-products carrier 13, which is used for weight measurement. The piezo element 32 is compressed to a greater or lesser extent depending on the weight of the conveyed product and outputs a corresponding weight signal to a transmitter 33, which then transmits the weight signal wirelessly to an evaluation unit. For example, the transmitter 33 may be a Bluetooth transmitter, an RFID transmitter, or an NFC transmitter, to name a few examples.

The invention is not limited to the preferred embodiments described above. Rather, a large number of variants and variations are possible which also make use of the inventive concept and therefore fall within the scope of protection. In particular, the invention also claims protection for the subject matter and the features of the dependent claims independently of the claims referred to in each case and in particular also without the features of the main claim. The invention thus comprises different aspects of the invention which enjoy protection independently of each other.

### LIST OF REFERENCE SIGNS

1 Cutting device
2, 3 Food product
4, 5 Conveyor tracks of the cutting device
6 Slices
7 Cutting blade
8 Cutting plane
9 Conveyor belt of the feeding device of the cutting device
10 Gripper of the feeding device of the cutting device
11 Product support
12, 13 Conveyed-products carrier
14 Conveying surface
15-18 Modules of the drive system
19 Gap between conveying surface and conveyed-products carrier
20 Camera
21 Control device
22, 23 Shingled stack of slices
24 Pins on the top of the conveyed-products carrier
25, 26 Recesses between the pins
27 Conveying path
28 Take-off conveyor for taking off the food products from the conveyed-products carrier
29 Pivot axis of the take-off conveyor
30 Loading surface on the conveyed-products carrier
31 Conveyor belt
32 Piezo element for weight measurement
33 Transmitter for transmitting the weight signal
AS Contactless drive system
h Height of gap between conveying surface and conveyed-products carrier
m Mass of the product to be conveyed
vf1, vf2 Feed rate in the conveyor tracks of the cutting device
vx1, vx2 Feed speed on the conveying surface
Δx1, Δx2 Offset when depositing the slices

1. A food-processing device for cutting food products into slices together forming a portion, comprising:
a cutting device configured to cut the slices from the food products;
a discontinuous conveyor configured to receive the cut slices after a cutting operation and to convey the received slices discontinuously, the discontinuous conveyor comprises at least one conveyed-products carrier which is configured to be moved freely in two dimensions within a conveying surface without being tied to a fixed conveying path and receives the cut slices; and
a scale configured to measure the weight of the conveyed-products carrier with the slices deposited thereon.

2. The food-processing device according to claim 1, wherein the scale is integrated into the conveyed-products carrier.

3. The food-processing device according to claim 1, wherein the scale has a piezo element which is compressed as a function of the loading state of the conveyed-products carrier and outputs a corresponding weight signal.

4. The food-processing device according to claim 1, wherein the conveyed-products carrier contains a transmitter configured to wirelessly transmit a weight signal.

5. The food-processing device according to claim 4, wherein the transmitter is an RFID transmitter, a Bluetooth transmitter or an NFC transmitter.

6. The food-processing device according to claim 1, wherein the discontinuous conveyor comprises a contactless drive system configured to move the conveyed-products carrier within the conveying surface along a freely programmable conveying path without contact between the conveyed-products carrier and the conveying surface.

7. The food-processing device according to claim 6, wherein
the scale is integrated into the contactless drive system,
the contactless drive system suspends the conveyed-products carrier with a predetermined drive power, and
a distance is set between the conveyed-products carrier and the conveying surface as a function of the weight of the conveyed-products carrier with the slices deposited thereon and the drive power of the drive system; and
further comprising a measuring device configured to measure the distance between the conveyed-products carrier and the conveying surface.

8. The food-processing device according to claim 7, wherein the measuring device comprises:
a distance sensor, and
a camera.

9. The food-processing device according to claim 7, further comprising a control device configured to keep the distance between the conveyed-products carrier and the conveying surface constant by adjusting the drive power and outputs the drive power required for this as a measure of the weight.

10. The food-processing device according to claim 9, wherein the measuring device comprises:
a distance sensor, and
a camera.

11. The food-processing device according to claim 7, further comprising a control device configured to keep the drive power constant and outputs the weight-dependent distance between the conveyed-products carrier and the conveying surface as a measure of the weight.

12. The food-processing device according to claim 11, wherein the measuring device comprises:
a distance sensor, and
a camera.

13. The food-processing device according to claim 1, wherein the conveyor is arranged in the line of fall of the slices so that the cut slices fall from the cutting device onto the conveyor.

14. A food-processing device for cutting food products into slices together forming a portion, comprising:
a cutting device configured to cut the slices from the food products;
a discontinuous conveyor configured to receive the cut slices after a cutting operation and to convey the received slices discontinuously; and
a scale configured to measure the weight of the received slices.

15. The food-processing device according to claim 14, wherein the conveyor is arranged in the line of fall of the slices so that the cut slices fall from the cutting device onto the conveyor.
